(19) United States
(12) Patent Application Publication
(10) Pub. No.: US 2025/0005683 A1
(43) Pub. Date: Jan. 2, 2025

(54) INTELLIGENT VIRTUAL DIGITAL ASSISTANT FOR TAX FILING

(71) Applicant: HRB Innovations, Inc., Las Vegas, NV (US)

(72) Inventors: Jason N. Ward, Lee's Summit, MO (US); Benjamin A. Kite, Lawrence, KS (US); Shylendran Chemmancherry, Overland Park, KS (US)

(21) Appl. No.: 18/216,964

(22) Filed: Jun. 30, 2023

(51) Int. Cl. G06Q 40/12

(52) U.S. Cl. CPC G06Q 40/123; G06F 40/40

(57) ABSTRACT

Systems and methods for assisting a user during a tax interview are disclosed. In some embodiments, the system may utilize historical data and machine learning algorithms to determine an optimal set of questions to the user. The questions may be order based on a desired result of the optimization algorithm. The user may respond to the questions and at each response, a new set of questions may be generated based on a real-time simulation of the potential questions. As the user continues to provide input, an error based on unknown information may reduce to a minimal error below a threshold. At this point, the interview may be complete, and the desired result may be maximized.

### BACKGROUND

### 1. Field

Embodiments of the invention generally relate to systems and methods for efficient tax completion and, more particularly, to systems and methods of employing specific artificial intelligence algorithms to determine optimal question orders for efficient tax completion.

### 2. Related Art

Every tax season, millions of Americans employ the help of tax professionals to ensure their taxes are completed accurately and efficiently. The tax season rush, especially as Tax Day approaches, can lead to supply shortages when it comes to the number of tax professionals available. It may be difficult to schedule an appointment with a tax professional due to the influx of demand. Further, many people may find it difficult to locate a tax professional that can accommodate their needs, such as one that speaks a particular foreign language or has an office that can accommodate a specific physical disability.

This results in many Americans having to complete their taxes without proper assistance or having to rely on tax completion services that are unable to tailor their advice to a wide range of tax scenarios. Accordingly, there is a need for tax return preparation systems that can interact with a wide range of users and provide an optimized and accurate method for filling out a tax return without the need for a human tax professional.

### SUMMARY

In some aspects, the techniques described herein relate to a system for assisting a user on tax return preparation comprising at least one processor, a user tax data store, wherein the user tax data store comprises one or more tax data variables corresponding to the user, and one or more non-transitory computer-readable media storing computer-executable instructions that, when executed by the at least one processor, perform a method of assisting the user on the tax return preparation. The method comprises generating a first order of questions based on historical data and an optimization algorithm for achieving a desired tax result, generating a first output configured to be presented to the user, wherein the first output is a first question of the first order of questions, receiving one or more inputs from the user in response to the first output, updating the one or more tax data variables based on the one or more inputs from the user, and determining a second order of questions based on the updated tax data variables, the historical data, and the optimization algorithm for achieving the desired tax result.

In some aspects, the techniques described herein relate to a method of assisting a user on tax return preparation. The method comprises generating a first order of questions based on historical data and an optimization algorithm for achieving a desired tax result, generating a first output configured to be presented to the user, wherein the first output is a first question of the first order of questions, receiving one or more inputs from the user in response to the first output, updating one or more tax data variables based on the one or more inputs from the user, and determining a second order of questions based on the updated tax data variables, the historical data, and the optimization algorithm for achieving the desired tax result.

In some aspects, the techniques described herein relate to a one or more non-transitory computer-readable media storing computer-executable instructions that, when executed by at least one processor, perform a method of assisting a user on a tax return preparation. The method comprises generating a first order of questions based on historical data and an optimization algorithm for achieving a desired tax result, generating a first output to be presented to the user, wherein the first output is a first question of the first order of questions, receiving one or more inputs from the user in response to the first output, updating one or more tax data variables based on the one or more inputs from the user, and determining a second order of questions based on the updated variables, the historical data, and the optimization algorithm for achieving the desired tax result.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform in accordance with embodiments of the invention;

FIG. 2 depicts an exemplary system in accordance with embodiments of the invention;

FIGS. 3A-3C depict an exemplary tree diagram in accordance with embodiments of the invention;

FIG. 4 depicts an exemplary flowchart for illustrating the operation of a method in accordance with embodiments of the invention; and

FIG. 5 depicts an exemplary flowchart for illustrating the operation of a method in accordance with embodiments of the invention.

The drawing figures do not limit the invention to the specific embodiments disclosed and described herein. The drawings are not necessarily to scale, emphasis instead being placed upon clearly illustrating the principles of the invention.

### DETAILED DESCRIPTION

In various embodiments, a virtual tax assistant system is disclosed to assist users in completion of tax returns. Systems consistent with the present disclosure allow for a user to communicate back and forth with a virtual tax assistant, where the virtual tax assistant gathers information from the user, and the user provides information to the virtual tax assistant. In some embodiments, natural language processing models are used to translate communications between the user and the virtual tax assistant. In some embodiments, the virtual tax assistant uses ordering rules to determine the ordering of questions to minimize the number of questions asked to the user to fill out a tax return associated with the user.

The subject matter of the current disclosure is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be understood by one skilled in the art and are intended to be captured within the scope of the claimed invention. Terms should not be interpreted as implying any particular ordering of various steps described unless the order of individual steps is explicitly described.

The following detailed description of embodiments of the disclosure references the accompanying drawings that illustrate specific embodiments in which the disclosure can be practiced. The embodiments are intended to describe aspects of the disclosure in sufficient detail to enable those skilled in the art to practice the invention. Other embodiments can be utilized, and changes can be made, without departing from the scope of the disclosure. The following detailed description is, therefore, not to be taken in a limiting sense. The scope of embodiments of the disclosure is defined only by the appended claims, along with the full scope of equivalents to which such claims are entitled.

In this description, references to “one embodiment,” “an embodiment,” “embodiments,” “various embodiments,” “certain embodiments,” “some embodiments,” or “other embodiments” mean that the feature or features being referred to are included in at least one embodiment of the technology. Separate references to “one embodiment”, “an embodiment,” “embodiments,” “various embodiments,” “certain embodiments,” “some embodiments,” or “other embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

### Operational Environment for Embodiments of the Invention

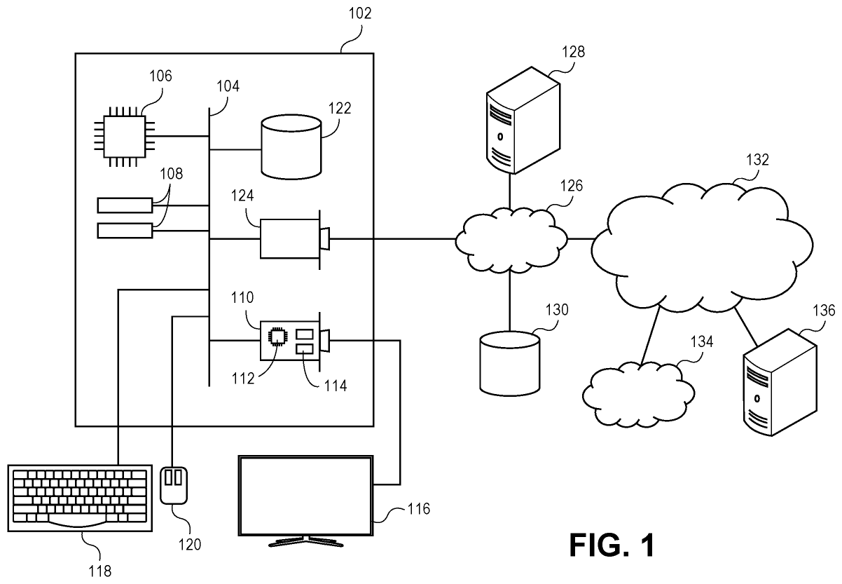

Turning first to FIG. 1, an exemplary hardware platform for certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components for illustrative purposes. In some embodiments, certain components may be arranged differently or absent. Additional components may also be present. Included in computer 102 is system bus 104, via which other components of computer 102 can communicate with each other. In certain embodiments, there may be multiple busses or components that may communicate with each other directly. Connected to system bus 104 is central processing unit (CPU) 106. Also attached to system bus 104 are one or more random-access memory (RAM) modules 108. Also attached to system bus 104 is graphics card 110. In some embodiments, graphics card 110 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also, on graphics card 110 is GPU memory 114. Connected (directly or indirectly) to graphics card 110 is display 116 for user interaction. In some embodiments no display is present, while in others, it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media and may be internally installed in computer 102 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable, but only non-transitory data storage. Examples of stored information include computer-useable instructions, data structures, program modules, and other data representations. In particular, computer-readable media may store computer-executable instructions that, when executed by at least one processor such as CPU 106, perform methods in accordance with embodiments of the present disclosure.

Finally, network interface card (NIC) 124 is also attached to system bus 104 and allows computer 102 to communicate over a network such as local network 126. NIC 124 can be any form of network interface known in the art, such as Ethernet, ATM, fiber, Bluetooth, or Wi-Fi (i.e., the Institute of Electrical and Electronics Engineers (IEEE) 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write, and seek operations, or any level of complexity in between. Some data stores may additionally provide management functions for data sets stored therein such as backup or versioning. Data stores can be local to a single computer such as computer 128, accessible on a local network such as local network 126, or remotely accessible over public Internet 132. Local network 126 is, in turn, connected to public Internet 132, which connects many networks such as local network 126, remote network 134 or directly attached computers such as computer 136. In some embodiments, computer 102 can itself be directly connected to public Internet 132.

### System for Virtual Tax Assistant

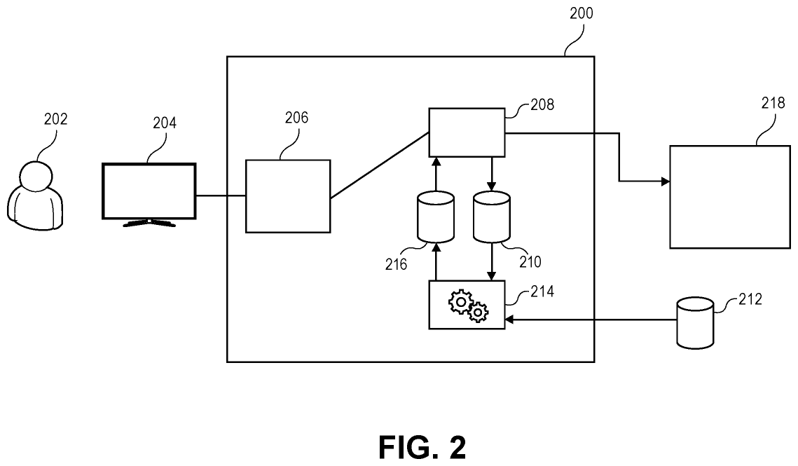

Turning now to FIG. 2, an exemplary system in accordance with embodiments of the invention is depicted. Broadly, virtual tax assistant 200 may present a question to user 202, and user 202 may input an answer to be received by virtual tax assistant 200 which, in some embodiments, may be or may comprise computer 102. For example, virtual tax assistant 200 may desire to know the full name of user 202. Therefore, virtual tax assistant 200 may provide user 202 with the question, “What is your name?” User 202 may then answer with “John Doe,” at which point virtual tax assistant 200 may use the name “John Doe” for further processing, computation, and filling out any relevant fields.

In some embodiments, user 202 provides information to virtual tax assistant 200 through tax assistant interface 204. Tax assistant interface 204 provides a front end into virtual tax assistant 200 for user 202 to enter the information needed to prepare any number of tax-related documents and a system and method by which user 202 can be prompted for information. It should be noted that user 202 can be a wide range of parties, including a taxpayer, an authorized third party, a professional tax preparer, and the like. Therefore, use of the term “user” herein is intended to encompass either or both of the taxpayer and any third party operating on behalf of the taxpayer. Additionally, a user may comprise an individual filing singly, a couple filing jointly, a business, or a self-employed filer.

Broadly, tax assistant interface 204 may receive input from user 202 (and vice versa) through any number or combinations of interfacing devices now known or later developed. In some embodiments, user 202 provides information to the virtual tax assistant 200 through speech. For example, user 202 may speak into a microphone to provide information to virtual tax assistant 200. In other embodiments, user 202 provides information to virtual tax assistant 200 using a keyboard, mouse, touchscreen, or similar input means. In still other embodiments, user 202 provides information to virtual tax assistant 200 through video input. For example, user 202 may provide information to the virtual tax assistant 200 using a webcam.

In a similar fashion, the virtual tax assistant 200 may communicate through tax assistant interface 204 using any number and combinations of interfacing devices now known or later developed. In some embodiments, virtual tax assistant 200 provides information to user 202 through auditory functionality. For example, communication from virtual tax assistant 200 may include spoken questions heard through one or more speakers. In such embodiments, virtual tax assistant 200 may provide information to user 202 in a language selected by user 202. In other embodiments, the virtual tax assistant 200 may communicate with user 202 by displaying information. For example, the virtual tax assistant 200 may present information to the user by displaying text on a screen. In still other embodiments, virtual tax assistant 200 may appear as a “talking head” on a screen accompanied by communication through speech.

In some embodiments, the communication provided to user 202 through tax assistant interface 204 is a question. For example, the communication provided to user 202 through tax assistant interface 204 may be, “What is your middle name?” In other embodiments, the communication provided to user 202 through tax assistant interface 204 may be a display of one or more tax forms. For example, user 202 may be able to view one or more tax forms as they are being filled out by virtual tax assistant 200.

In some embodiments, virtual tax assistant 200 relies on communication unit 206 for converting user input into a form understandable and readable by virtual tax assistant 200 (and vice versa). For example, communication unit 206 may utilize machine learning to process communication from and to user 202. In some embodiments, communication unit 206 may be configured to process any language known or later developed, including English, Chinese, American Sign Language, and the like.

In some embodiments, communication unit 206 relies on one or more technologies for interpreting, manipulating, and comprehending human language (e.g., natural language processing). In such embodiments, communication unit 206 may rely on any number of natural language processing techniques now known or later developed, including, but not limited to, supervised natural language processing, unsupervised natural language processing, natural language understanding, statistical natural language processing, machine learning, deep learning, and similar techniques.

In some embodiments, communication unit may be able to perform any number of abilities now known or later developed that may be necessary in order for communication unit 206 to interpret input received by user 202, including, but not limited to, part-of-speech tagging, word sense disambiguation, named entity recognition, summarization, topic modeling, text classification, keyword extraction, lemmatization and stemming, co-reference resolution, sentiment analysis, and the like.

In a complementary manner, communication unit 206 may rely on one or more technologies for recognizing, understanding, and translating human language into machine-readable data (e.g., speech recognition and voice recognition). In some embodiments, communication unit 206 relies on any number of speech and voice recognition methods and techniques now known or later developed, including, but not limited to, machine learning, deep learning, automatic speech recognition, n-gram models, the Hidden Markov model, recurrent neural networks, the Connectionist Temporal Classification algorithm, and any other speech and voice recognition techniques.

Further, in order to present understandable information to user 202, communication unit 206 may rely on one or more techniques for converting machine-readable data into human language (e.g., natural language generation). To accomplish this, communication unit 206 may rely on any number of language generation techniques now known or later developed, including, but not limited to, content determination, data interpretation, document planning, sentence aggregation, grammaticalization, language implementation, and similar language generation techniques.

Upon processing input from user 202, communication unit 206 may then transmit the readable input to ordering model 208. In some embodiments, ordering model 208 is interconnected with a user tax data store 210, an external tax data store 212, a rules generation engine 214, a rules store 216, and a third-party interface 218. As depicted in FIG. 2, these components are interconnected in such a way that they provide feedback to successively refine the question ordering during an interview as additional information is received from the user and as additional information is received from other tax data sources.

In some embodiments, user tax data store 210 stores information input from or connected to user 202. Broadly, information inputted from user 202 may be any tax-related information, including, but not limited to, information needed to complete a tax return. As such, user tax data store 210 includes a list of all possible tax data variables. For example, user tax data store 210 may include variables for gross income, date of birth, social security number, number of dependents, and any information that could be required for tax purposes.

Information in user tax data store 210 may be provided by user 202, imported from a prior tax return for the user, or imported from an external source (e.g., a bank or a payroll provider) based on data provided by user 202. Tax data may also include values derived from other tax data computed by ordering model 208. For example, the user's Adjusted Gross Income (AGI) is a tax data item. The user's AGI is not entered directly by user 202 but is calculated as the taxpayer's gross income minus the above-the-line deduction. The taxpayer's gross income and above-the-line deduction are themselves calculated values based on other calculated values and values directly provided (or imported) by user 202. Of course, it must be appreciated that many hundreds or even thousands of tax data variables may be present and that those explicitly mentioned are merely exemplary and non-limiting.

In some embodiments, an external tax data store 212 provides information to virtual tax assistant 200. The data contained in external tax data store 212 may include any data related to the tax preparation process. In some embodiments, external tax data store 212 includes relevant tax law and guidance. In other embodiments, external tax data store 212 includes prior conversations between customers and tax professionals. In still other embodiments, external tax data store 212 includes any and all data maintained by a tax preparation company.

In some embodiments, user tax data store 210 and external tax data store 212 then provide user tax data and external tax data to rules generation engine 214. Rules generation engine 214 processes user tax data from user tax data store 210 as well as information from external tax data store 212 to generate ordering rules for later use by ordering model 208. A person of skill in the art will appreciate that such a calculation, particularly on a large data set, is only possible with the aid of computer-assisted machine-learning algorithms and techniques such as multivariate analysis and/or cluster analysis. In some embodiments, big-data techniques, including generalized linear modeling and k-means clustering can be used to generate rules. In other embodiments, tree-based algorithms such as gradient-boosting machines can be used.

Additionally, it will be appreciated that, as additional tax returns are added to user tax data store 210 and external tax data store 212, the ordering rules can be regenerated by re-analyzing the larger data set to improve accuracy. Accordingly, rules generation engine 214 may regularly regenerate ordering rules based on the most current data from user tax data store 210 and external tax data store 212. In some embodiments, rules generation engine 214 regenerates ordering rules after each input by user 202. In other embodiments, rules generation engine 214 regenerates ordering rules after the session with user 202 is completed. In still other embodiments, rules generation engine 214 regenerates ordering rules after a predetermined time interval has passed. For example, rules generation engine 214 may regenerate ordering rules every 30 days. In further embodiments, rules generation engine regenerates ordering rules when directed by a system administrator. In still other embodiments, rules generation engine 214 may regenerate ordering rules after a tax form is completed.

As described above, the ordering rules may be periodically regenerated by rules generation engine 214. In some embodiments, all rules are removed and regenerated when rules generation engine 214 updates ordering rules store 216. In other embodiments, new rules are added to ordering rules store 216 whenever they are generated (i.e., whenever new efficiencies for asking questions of a user are discovered). In some embodiments, ordering rules store 216 is seeded with empirically determined rules. In some such embodiments, these rules are retained even when automatically generated rules are refreshed. In other embodiments, these rules are used to make initial ordering determinations but can be updated or replaced by rules generation engine 214.

Once rules store 216 has been populated appropriately with rules, ordering model 208 can apply the rules to a user session. Based on the output of rules generation engine 214, ordering rules store 216 may be populated with one or more rules for determining an order for asking questions of a user in constructing a tax return. At a high level, the ordering rules are meant to provide rules used by ordering model 208 to order questions such that the number of questions asked of user 202 is minimized. For example, one rule might state that the option to take the standard deduction is removed when the user's total deduction amount is above a certain value. Another rule might add one or more questions based on a user's indication that they have dependents. Generally, the ordering rules may be dependent on the current values of the tax variables stored in the user tax data store 210 as well as the most recent input from user 202.

Additionally, the ordering rules are meant to assist ordering model 208 with computing the uncertainty level corresponding to unknown tax variables in user tax data store 210. For example, if ordering model 208 has no indication of what a specific unknown tax variable value may be, the uncertainty level for that value may be 100%. For another example, if ordering model 208 is completely certain as to the value of a specific unknown variable in user tax data store 210, the uncertainty level for that value may be 0%. In some embodiments, ordering model 208 may fill in the value of one or more unknown tax variables in user tax data store 210 when the uncertainty level of the one or more unknown tax variables falls below a certain threshold. For example, in order to provide efficiency in asking questions of user 202, ordering model 208 may fill in the value of unknown tax variables when the uncertainty level falls below 25%. For another example, in order to provide heightened accuracy, ordering model 208 may fill in the value of unknown tax variables when the uncertainty level falls below 3%.

Broadly, ordering model 208 may update unknown tax variables in user tax data store 210 when ordering model 208 determines that a particular outcome has reached a predetermined likelihood threshold. More particularly, one or more ordering rules may assist ordering model 208 in computing a distribution for the value of a specific unknown tax variable in user tax data store 210. In such embodiments, one or more additional rules may help ordering model 208 determine when a distribution is small enough to which ordering model 208 can fill in an unknown tax variable.

Distributions may represent the likelihood of one or more potential outcomes that may dictate the values of one or more unknown tax variables. Ordering model 208 may compute the distribution error of any particular variable or scenario by comparing known information that may affect the value of a particular tax variable with unknown information that may affect the value of a particular tax variable. As the distribution error of a particular variable or scenario decreases, so will the likelihood that unknown information will affect the value of the particular variable or scenario. In some embodiments, as more input is received from user 202 and the distribution errors associated with one or more unknown tax variables are minimized, the session will conclude and no further question ordering optimization by ordering model will commence. At a high-level, ordering model 208 optimizes the tree diagram (e.g., reorders questions, adds questions, and removes questions) such that the most impactful questions are presented to the user first with the goal of maximizing the economic impact to the user. The economic impact to the user may be maximized when the amount of time to complete the tax return is minimized or the number of questions asked of the user is minimized. The tree diagram may be generated using the rules generated by rules generation engine 214 that are based on various forms of historical data (such as data from the user tax data store as well as from the external tax data store). In some embodiments, ordering model 208 may regenerate the tree diagram every time a new user input is received. In other embodiments, ordering model 208 may regenerate the tree diagram after a plurality of user inputs are received. Similarly, the tree diagram may be generated for all forms and all data associated with the user, or the tree diagram may only be generated for a single form that the user is currently completing.

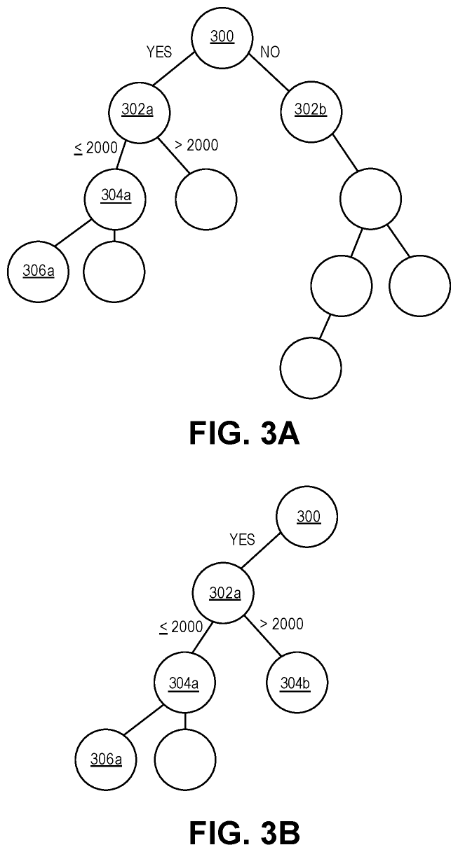

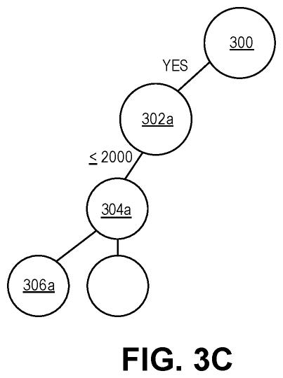

FIGS. 3A-3C depict exemplary tree diagrams for illustrating the ways in which ordering model 208 might apply one or more ordering rules such that ordering model 208 optimizes the question ordering presented to the user in order to achieve a desired tax result. It must be noted that the tree diagrams depicted in FIGS. 3A-3C are meant to be exemplary in nature and in no way are meant to limit the functionality of ordering rules as applied by ordering model 208.

Upon starting a session with user 202, ordering model 208 might construct an initial question order with many possible questioning routes. As depicted by the tree diagram in FIG. 3A, the initial question order is a series of interconnected nodes (e.g., questions), where a particular answer from the user may dictate the next question asked. The initial ordering of the questions may provide a most likely shortest route to the end of the interview while maximizing the tax return of the user. For example, ordering model 208 might prompt user 202 with a first question 300, where first question 300 may be answered with a “yes” or a “no.” Upon receiving a “yes” input from user 202, ordering model 208 may then rely on an ordering rule to regenerate the tree, eliminating second question 302b and all other questions dependent on second question 302b from the question tree, as depicted in FIG. 3B. This process eliminates questions from the overall tree structure thus, eliminating potential outcomes and eliminating unnecessary processing be eliminating potential paths to unwanted results.

From there, ordering model may present user 202 with the next question in the newly generated tree. For example, ordering model 208 may then ask user 202 a second question 302a, where the second question 302a is to be answered with a numerical value. As stated above, ordering model may regenerate the tree such that questions are reordered. For example, upon receiving a numerical value of 6001, ordering model 208 may use one or more rules to regenerate a new tree, thereby eliminating third question 304b and switching the order of third question 304a and fourth question 306a, as depicted by FIG. 3C.

Once all appropriate rules have been applied, ordering model 208 may generate an order in which to ask questions of the user. In some embodiments, ordering model 208 may generate a single question. In other embodiments, ordering model 208 may generate an order for asking a plurality of questions on a particular sheet.

In some embodiments, ordering model 208 generates a question ordering after a single input from user 202 is received. In other embodiments, ordering model 208 may only generate a question ordering upon receiving a plurality of inputs from user 202. For example, ordering model 208 may only generate a question ordering upon receipt of the information to complete a full tax form, such as a 1040 tax form. In still other embodiments, ordering model 208 may generate a question ordering after a specific time interval.

In some embodiments, ordering model 208 may determine that a tax return is complete as indicated by user tax data store 210 and no further input is required by a user. After a tax return is completed, virtual tax assistant 200 may provide the completed return to a third party via third-party interface 218. For example, virtual tax assistant 200, upon instruction by a user 202, may provide the completed tax return to a human tax professional for further verification. For another example, virtual tax assistant 200 may transmit the completed tax return to the Internal Revenue Service. In some embodiments, virtual tax assistant 200 may prompt user 202 to decide whether user 202 wants their completed tax return to be sent to a third party. In other embodiments, virtual tax assistant 200 may send the completed tax return to a third party automatically.

### Assisting a User in Tax Return Preparation

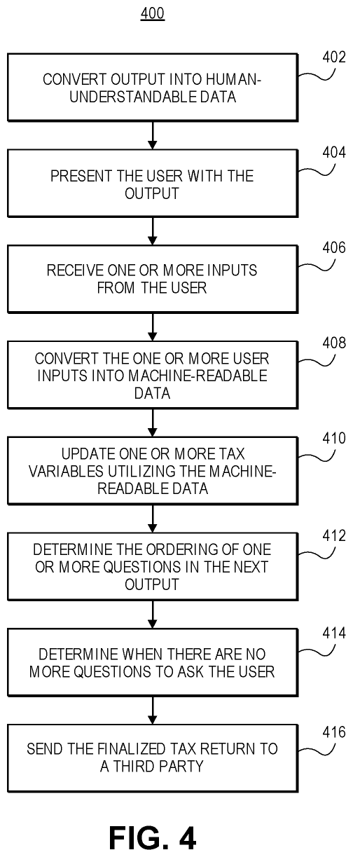

Turning now to FIG. 4, an exemplary flow chart is depicted, illustrating the operation of method 400 for assisting a user in preparing a tax return.

At step 402, the computer-readable output may be converted into output understandable by the user. As discussed above with respect to FIG. 2, in order to present understandable information to the user, one or more techniques for converting machine-readable data into human language (e.g., natural language generation) may be relied on. Any number of language generation techniques now known or later developed may be utilized, including, but not limited to, content determination, data interpretation, document planning, sentence aggregation, grammaticalization, language implementation, and similar language generation techniques.

At step 404, the human-understood output is presented to a user. In some embodiments, the output presented to the user is audio output. For example, the output may be speech in a language preselected by the user. In other embodiments, the output presented to the user is written output. For example, the output may be text displayed on a screen. In still other embodiments, the output presented to the user is tax forms displayed on a screen. For example, the output may be a tax form that is updated as more fields are filled out.

In some embodiments, the output presented to the user is a question or series of questions. For example, the output presented to the user may be the question, “What is your middle name?” In other embodiments, the communication provided to user 202 through the tax assistant interface may be a display of one or more tax forms. For example, the user may be able to view one or more tax forms as they are being filled out. This proves advantageous, as the user can ensure the accuracy of the forms being completed as they are completed.

At step 406, input from the user is received. Broadly, as discussed above with respect to tax assistant interface 204, input from the user may be received through any number or combinations of interfacing devices now known or later developed. In some embodiments, user input is received through speech. For example, the user may speak into a microphone attached to the system. In other embodiments, the user provides input using a keyboard, mouse, touchscreen, or similar input means. In still other embodiments, the user provides input through video. For example, the user may provide input through a web camera attached to the system.

At step 408, the user input is converted into machine-readable data. In some embodiments, as discussed above with respect to communication unit 206, one or more technologies for interpreting, manipulating, and comprehending human language (e.g., natural language processing) may be relied upon for converting user input into machine-readable data. In such embodiments, any number of natural language processing techniques now known or later developed may be relied upon, including, but not limited to, supervised natural language processing, unsupervised natural language processing, natural language understanding, statistical natural language processing, machine learning, deep learning, and similar techniques.

In some embodiments, any number of abilities now known or later developed may be necessary in order to interpret input received by the user, including, but not limited to, part-of-speech tagging, word sense disambiguation, named entity recognition, summarization, topic modeling, text classification, keyword extraction, lemmatization and stemming, co-reference resolution, sentiment analysis, and the like. In a complementary manner, as discussed above with respect to communication unit 206, one or more technologies for recognizing, understanding, and translating human language into machine-readable data (e.g., speech recognition and voice recognition) may be relied upon including, but not limited to, machine learning, deep learning, automatic speech recognition, n-gram models, the Hidden Markov model, recurrent neural networks, the Connectionist Temporal Classification algorithm, and any other speech and voice recognition techniques.

At step 410, one or more tax variables may be updated using the machine-readable data. In some embodiments, one or more tax variables are located in a user tax data store associated with the user. Broadly, the one or more tax variables may be any tax-related information including, but not limited to, information needed to complete a tax return. As such, the user tax data store may include a list of all possible tax data variables. For example, the user tax data store may include variables for gross income, date of birth, social security number, number of dependents, and any information that could be required for tax purposes.

In some embodiments, the one or more tax variables may also include values derived from other tax data computed by the ordering model. For example, the user's Adjusted Gross Income (AGI) may be a tax variable. The user's AGI may not be entered directly by the user but calculated as the user's gross income minus the above-the-line deduction. The user's gross income and above-the-line deduction are themselves calculated values based on other calculated values and values directly provided (or imported) by the user. Of course, it must be appreciated that many hundreds or even thousands of tax data variables may be present and that those explicitly mentioned are merely exemplary and non-limiting.

In some embodiments, as discussed above with respect to user tax data store 210, the machine-readable data corresponds to one or more unknown tax variables. In such embodiments, one or more unknown tax variables may be updated to contain the machine-readable data. For example, if the machine-readable data is “gross income,” the machine-readable data may be used to fill in the “gross income” field. In some embodiments, as discussed above with respect to FIG. 2, one or more unknown tax variables may be filled in using the machine-readable data when the uncertainty level associated with the one or more unknown tax variables falls below a predetermined threshold. In other embodiments, one or more unknown tax variables may be filled in using the machine-readable data when a predetermined value distribution associated with the one or more unknown tax variables is met.

At step 412, the ordering of questions may be determined using an ordering model. In some embodiments, determining the ordering of questions is done using method 500 (discussed below). In other embodiments, determining the ordering of questions is done using a method substantially similar to that depicted with respect to method 500. In still other embodiments, determining the ordering of questions is done using an entirely different method than that depicted in method 500.

In some embodiments, in determining that more questions need to be asked of the user, method 400 may proceed back to step 402, where the new questions are converted into output understandable by the user. In such embodiments, method 400 may continue to iterate until the user's tax return is determined to be complete. In other embodiments, method 400 may continue to iterate until a preselected time interval has occurred.

At step 414, the completion of the user's tax return is determined by the ordering model. In some embodiments, the completion of a tax return is determined when the user tax data store indicates that no unknown variables are present. In other embodiments, the completion of a tax return is indicated by the ordering model indicating that no more questions are to be asked.

At step 416, the completed tax return may be sent to a third party. In some embodiments, the third party is a tax professional. In other embodiments, the third party is the Internal Revenue Service. As discussed with respect to FIG. 2, the user may prompt the virtual tax assistant to transmit the completed tax return to a third party. For example, the user may request the completed tax return be sent to a tax professional for review before being filed with the IRS.

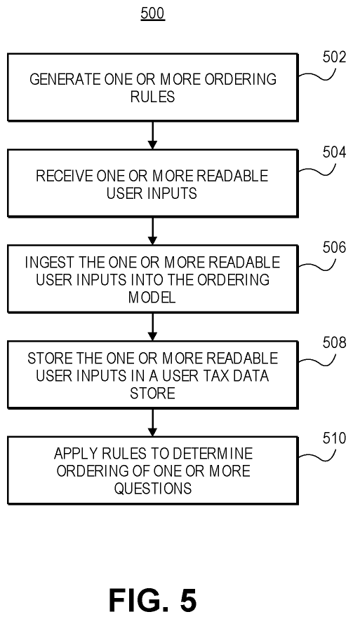

Turning now to FIG. 5, an exemplary flow chart is depicted, illustrating the operation of method 500 for determining the ordering of questions using machine learning.

At step 502, one or more ordering rules may be generated by a rules generating engine. As described above with respect to rules generation engine 214, the engine used to generate the ordering rules may utilize multiple sources of tax data. In some embodiments, the rules generating engine utilizes user tax data as well as external tax data to generate ordering rules. For example, the rules generating engine may utilize previous conversations held between tax professionals and taxpayers to generate ordering rules. Additionally, as additional tax returns are added to user tax data store 210 and external tax data store 212, the ordering rules can be regenerated by re-analyzing the larger data set to improve accuracy. Accordingly, rules generation engine 214 may regularly regenerate ordering rules based on the most current data from user tax data store 210 and external tax data store 212.

At step 504, machine-readable data may be received by an ordering model. As discussed with respect to FIG. 2, an ordering model may be provided machine-readable data by a communication unit. The communication unit may utilize any number of natural language processing techniques and speech recognition techniques to convert user input into machine-readable data. In some embodiments, the machine-readable data may be in any form now known or later developed, including, but not limited to, assembly code, binary values, and similar data forms.

At step 506, the machine-readable data is used to populate one or more variables in the user tax data store. In some embodiments, as discussed above with respect to user tax data store 210, the machine-readable data used to populate the user tax data store may be data directly corresponding to one or more variables in user tax data store. In other embodiments, the machine-readable data may be used to recompute one or more variables in user tax data store.

At step 508, the machine-readable data is ingested into the ordering model. Broadly, the machine-readable data can include any number of data points before being ingested. For example, the machine-readable data may be a single answer input by the user. For another example, the machine-readable data may be a plurality of answers corresponding to a completed tax form.

At step 510, one or more ordering rules are applied to determine the ordering of one or more questions. At a high level, the ordering rules are meant to provide rules by which the ordering model is to order questions such that the number of questions asked of user is minimized. For example, one rule might state that the option to take the standard deduction is removed when the user's total deduction amount is above a certain value. Another rule might add one or more questions based on a user's indication that they have dependents. Generally, the ordering rules may be dependent on the current values of the tax variables stored in the user tax data store as well as the machine-readable data.

Additionally, as discussed above with regard to FIG. 2, the ordering rules are meant to assist the ordering model with computing the uncertainty level corresponding to unknown tax variables in the user tax data store. In some embodiments, the ordering model may fill in the value of one or more unknown tax variables in the user tax data store when the uncertainty level of the one or more unknown tax variables falls below a certain threshold. In some embodiments, as discussed above, one or more ordering rules may assist the ordering model in computing a distribution for the value are they specific unknown tax variable in the tax data store. In such embodiments, one or more additional rules may help the ordering model determine when a distribution is small enough to which the ordering model can fill in an unknown tax variable.

Although the invention has been described with reference to the embodiments illustrated in the attached drawing figures, it is noted that equivalents may be employed, and substitutions made herein without departing from the scope of the invention. Having thus described various embodiments, what is claimed as new and desired to be protected by Letters Patent includes the following:

1. A system for assisting a user on tax return preparation comprising:
at least one processor;
a user tax data store, wherein the user tax data store comprises one or more tax data variables corresponding to the user; and
one or more non-transitory computer-readable media storing computer-executable instructions that, when executed by the at least one processor, perform a method of assisting the user on the tax return preparation, the method comprising:
generating a first order of questions based on historical data and an optimization algorithm for achieving a desired tax result;
generating a first output configured to be presented to the user,
wherein the first output is a first question of the first order of the questions;
receiving one or more inputs from the user in response to the first output;
updating the one or more tax data variables based on the one or more inputs from the user; and
determining a second order of the questions based on the one or more tax data variables, the historical data, and the optimization algorithm for achieving the desired tax result.

2. The system of claim 1, wherein the method further comprises:
transmitting, to a third party, a finalized tax return corresponding to the user.

3. The system of claim 1, wherein the method further comprises:
providing the first output as an audio signal to the user; and
receiving the one or more inputs as audio from the user.

4. The system of claim 1, wherein the method further comprises:
generating the first output using natural language generation; and
providing the first output as an audio signal.

5. The system of claim 1, wherein the method further comprises:
receiving the one or more inputs as an audio signal; and
translating the one or more inputs using natural language processing.

6. The system of claim 1, wherein determining the second order of the questions comprises:
generating one or more ordering rules;
receiving the one or more inputs;
ingesting the one or more inputs into an ordering model; and
applying the one or more ordering rules, wherein applying the one or more ordering rules determines the second order of the questions.

7. The system of claim 6, wherein generating the one or more ordering rules is based on at least a portion of the one or more tax data variables in the user tax data store and external tax data in an external tax data store.

8. A method of assisting a user on tax return preparation comprising:
generating a first order of questions based on historical data and an optimization algorithm for achieving a desired tax result;
generating a first output configured to be presented to the user,
wherein the first output is a first question of the first order of the questions;
receiving one or more inputs from the user in response to the first output;
updating one or more tax data variables based on the one or more inputs from the user; and
determining a second order of the questions based on the one or more tax data variables, the historical data, and the optimization algorithm for achieving the desired tax result.

9. The method of claim 8, wherein determining the second order of the questions comprises:
generating one or more ordering rules;
receiving the one or more tax data variables and the historical data;
ingesting the one or more tax data variables and the historical data into an ordering model;
applying the one or more ordering rules to determine the second order of the questions; and
storing the one or more tax data variables in a user tax data store.

10. The method of claim 9, wherein generating the one or more ordering rules is based on at least a first portion of the one or more tax data variables in the user tax data store and at least a second portion of external tax data in an external tax data store.

11. The method of claim 8 further comprising:
transmitting, to a third party, a finalized tax return corresponding to the user.

12. The method of claim 8, wherein updating the one or more tax data variables comprises:
recomputing one or more values associated with the one or more tax data variables utilizing the one or more inputs from the user.

13. The method of claim 8, wherein determining the second order of the questions occurs after a plurality of user inputs is received, wherein the plurality of user inputs corresponds to one or more fields associated with a tax form.

14. One or more non-transitory computer-readable media storing computer-executable instructions that, when executed by at least one processor, perform a method of assisting a user on a tax return preparation, the method comprising:
generating a first order of questions based on historical data and an optimization algorithm for achieving a desired tax result;
generating a first output to be presented to the user,
wherein the first output is a first question of the first order of the questions;
receiving one or more inputs from the user in response to the first output;
updating one or more tax data variables based on the one or more inputs from the user; and
determining a second order of the questions based on the one or more tax data variables, the historical data, and the optimization algorithm for achieving the desired tax result.

15. The media of claim 14, wherein the optimization algorithm comprises one or more ordering rules.

16. The media of claim 14, wherein the method further comprises:
generating the first output using natural language generation; and
providing the first output as an audio signal.

17. The media of claim 14, wherein the method further comprises:
receiving the one or more inputs from the user as an audio signal; and
translating the one or more inputs using natural language processing.

18. The media of claim 14, wherein the method further comprises:
applying the optimization algorithm to compute one or more uncertainty levels corresponding to one or more unknown tax data variables.

19. The media of claim 14, wherein the method further comprises:
applying the optimization algorithm to compute one or more value distributions corresponding to one or more unknown tax data variables.

20. The media of claim 14, wherein the method further comprises:
applying the optimization algorithm to determine when a tax return is complete.
